(19) United States
(12) Patent Application Publication
(10) Pub. No.: US 2026/0309417 A1
(43) Pub. Date: Oct. 8, 2026

(54) A HEATING SYSTEM AND A METHOD FOR INTEGRATING A HEATING SYSTEM INTO A DRYING PLANT

(71) Applicant: GEA Process Engineering A/S, Søborg (DK)

(72) Inventors: Riccardo Bergamini, Søborg (DK); Lorenzo Bellemo, Copenhagen (DK)

(73) Assignee: GEA Process Engineering A/S, Søborg (DK)

(21) Appl. No.: 19/479,445

(22) PCT Filed: May 1, 2024
(86) PCT No.: PCT/EP2024/061990

§ 371 Date: Oct. 28, 2025

(30) Foreign Application Priority Data
May 4, 2023 (EP) 23171627.5

(51) Int. Cl. F26B 23/00

(52) U.S. Cl. CPC F26B 23/002

(57) ABSTRACT

A heating system (1) comprising a heat pump system is provided, the heat pump system comprising a heat pump (2) operating with a primary fluid and a first sink heater (3), the heat pump (2) being connected to the first sink heater (3), wherein the first sink heater (3) is configured to heat a process medium, the heating system further comprising at least one primary heat source (9) and one secondary heat source (10), the heat pump (2) being connected to the primary heat source (9), wherein the primary heat source (9) is connected to a refrigeration plant (11), the primary heat source (9) being connected to the secondary heat source (10) via a booster (5). A method for integrating a heating system into a drying plant is also provided.

### TECHNICAL FIELD

The present invention relates to a heating system installed in a drying plant, the heating system comprising a heat pump system, the heat pump system comprising a heat pump operating with a primary fluid and a first sink heater, the heat pump being connected to the first sink heater, wherein the first sink heater is configured to heat a process medium, the heating system further comprising at least one primary heat source and one secondary heat source, the heat pump being connected to the primary heat source. A method for integrating a heating system into a drying plant is also provided.

### BACKGROUND ART

Spray drying plants are usually quite large energy intensive installations with a high specific thermal energy demand on a high temperature level of above for example 200 °C, which is therefore mostly provided by a primary energy combustion process with high greenhouse gas emissions. The combustion process provides heating energy to a process gas or process medium—usually ambient air—at a temperature as high as needed for the entry into the drying process, usually between about 170 °C and 240 °C, sometimes even higher.

Spray drying plants may comprise devices for air handling for all air streams needed for the process (i.e. air heaters, supply fans, dehumidifiers, coolers, and systems for exhaust air cleaning etc., which equipment in the present context is designated the air handling unit), product handling (i.e. feed pump, atomizer etc.), air disperser, drying chamber, heat recovery, and powder recovery. All systems can be provided with pre- and post-treatment equipment, for example evaporators, homogenizers, fluid bed dryer/cooler, agglomerator, de-duster and conveyor etc., so that the plant meets individual product specifications, operational safety, and environmental protection requirements. Also, the plants are available in open, closed, semi-closed and aseptic cycle versions.

The use of a heat pump for heat transfer from dryer exhaust gas for the single task of pre-heating a process gas in a spray-drying facility is a well-known concept. In WO 2018/091049 A1, a drying system comprising a drying plant and a heat pump assembly is disclosed.

Certain types of heat pumps (e.g. using CO2, H2O, NH3 or hydrocarbons as refrigerants) can be used to obtain high temperatures up to 150 °C, with ongoing developments to increase this maximum temperature. In such heat pumps, the refrigerant releases heat in the supercritical phase, i.e. it is cooled at nearly constant pressure without condensing, or in the subcritical phase. At the same time, such heat pumps can be used to supply cold water at low temperatures (approaching 0 °C. when cooling pure water). In particular, CO₂ heat pumps can provide high temperature heating and low temperature cooling with single-stage compression.

However, when integrating a heat pump into an industrial drying plant it is generally advantageous, from an energy and economic point of view, to use a process requiring active cooling as a heat source. In this, active cooling means that it rejects heat at the expense of additional energy, e.g. by means of a fluid cooled down by a refrigeration plant or refrigeration system, such as a chiller or a cooling tower. Many plants equipped with a dryer host processes that need active cooling and, as such, they are equipped with refrigeration plants and/or cooling towers. However, the heat rejected by such cooling processes is generally not enough to satisfy all the heat required to run a heat pump integrated in the dryer which supplies a large portion of the heat need of such dryer (i.e. that can reach high temperatures beyond 90 °C). In principle, the higher the temperatures, the more active cooling is required for the system. As such, the cooling requirement of the plant becomes the bottleneck in designing such a heat pump. In general, this situation may lead to two possible scenarios: a) The heat pump is sized according to the base cooling load. In this way, it is sure that the heat pump has always the required heat source available, and so it can stably run at full capacity. However, it will deliver only a limited portion of the heating needs of the dryer (i.e. heat up the air to low or moderate temperatures) and, at times at which the cooling need is higher than part load, it will not deliver all the cooling need to such processes. b) The heat pump is sized according to the heating need of the dryer. In this way the heat pump does not always have enough heat source available, resulting in two detrimental effects: i) the heat pump will function at part load for some periods of time. This may increase the payback of such an investment, as the heat pump will be sized according to the maximum load, but it will deliver such load only a limited time. ii) Fluctuations in heat source available could possibly induce fluctuations in heat pump load, increasing the risk of process instability. As an example, a 10% decrease in heat source available could result in a 10 °C. decrease in air temperature supplied by the heat pump system. If such a decrease happens over a short amount of time (e.g. 10 minutes), for example because a process requiring cooling in the plant is stopped, this could result in reduced production capacity of the dryer.

Both said options entail drawbacks, as the most desirable situation is that the heat pump delivers the largest possible extent of heating to the dryer, while delivering the largest possible extent of cooling to processes which need cooling, while stably running at the maximum possible capacity.

### SUMMARY OF THE INVENTION

The present invention relates to an improved heat pump system that can result in increased energy, cost and emissions savings while ensuring stable operation of the heat pump system close to its maximum capacity.

In a first aspect of the invention, this and further objects are achieved with a heat pump system of the kind mentioned in the introduction, which is furthermore characterized in that the primary heat source is connected to a refrigeration plant, the primary heat source being connected to the secondary heat source via a booster, and that an operating medium is configured to flow into the booster and the booster is configured to adjust the enthalpy flow rate of the operating medium.

The adjustment of the enthalpy flow rate may be understood as the adjustment of the temperature and/or flow rate of the operating medium. The booster may thus be configured to adjust the temperature and/or flow rate of the operating medium. In principle, adjustment of the pressure is conceivable as well.

The term “configured to flow” is intended to encompass conditions in which the heating system is in operation and the operating medium flows through the booster. Alternatively, the term “configured to flow” is intended to encompass conditions in which the heating system is not in operation and the system and/or booster is configured such that the operating medium flows through the booster when in operation. The operating medium may be present in the booster in other conditions too.

The components mentioned above and further below may not be physically connected, but there is a connection allowing a process medium to flow into a first component and then to a second component etc. Additionally or alternatively, the components may be indirectly connected such that energy flows or is transferred from one to the other. Indirect connection between the components may be understood as the components being separated in different hydraulic systems.

Most high-temperature systems, with the process air temperature being in the range of 90 °C to 250 °C, may benefit from the present connection of the heating system. However, the invention is not only limited to that specific temperature range.

With the present system, it is possible to supply a large portion (or all) of the heat demand of the dryer by means of a heat pump able to heat up the process air to high temperatures beyond 90 °C. This may ensure energy and/or emissions savings higher than 30% and up to 100% in conventional dryers.

Furthermore, it is possible to supply a large portion (or all) of the cooling demand of the processes present on site at all times, even when this demand varies. In this way, the useful cooling delivered by the heat pump may be close to its maximum potential in all circumstances.

In addition, stability of operation of the heat pump system may be achieved close to its maximum capacity. In this way minimum fluctuation of air temperature supplied to the dryer (caused by a reduction or fluctuation of capacity of the heat pump) is ensured, ensuring stability of operation of the dryer itself, highly reducing the risk of impacting negatively productivity compared to conventional heating systems.

The above-mentioned advantages are achieved by increasing the enthalpy flow rate of the operating medium linked to the process requiring cooling (primary heat source), with one or multiple secondary heat sources, when the primary heat source is not sufficient to ensure the required load of the heat pump system. This can be achieved by either increasing the temperature of the operating medium (“temperature boosting”) and/or its flow rate (“flow rate boosting”).

The heat pump may receive heat by means of a water circuit. The water circuit may comprise the operating medium. The operating medium may thus be water. The operating medium may operate in the circuit positioned on the cold side of the heat pump.

The primary heat source may comprise the operating medium. The operating medium may be heated by the primary heat source. The operating medium may then exit the primary heat source and enter the booster. The operating medium may alternatively be called primary heat medium.

In an alternative embodiment, the operating medium before entering into the booster is mixed with another operating medium coming from a heat exchanger and/or a heat source.

The operating medium may be heated up by the refrigeration plant. The refrigeration plant may reject heat, which may be used to heat the operating medium.

In an embodiment, the heating system further comprises a second primary heat source, the second primary heat source being connected or placed in parallel with the primary heat source. Alternatively, the primary heat source may comprise a first and a second primary heat source, the first and second primary heat sources being placed in parallel with each other.

In an embodiment, the secondary heat source is placed or connected in parallel with the primary heat source and/or the booster.

In additional or alternative embodiment, one or multiple heat sources are connected in parallel with the primary heat source. Accordingly, a tertiary heat source may be placed in parallel with the primary and/or secondary heat source. In an embodiment, multiple primary heat sources and/or multiple secondary heat sources are comprised in the heating system.

The primary heat source may be any process and/or device requiring active cooling. For example, it may be a cooling tank which is operated to keep a product (e.g. milk) at low temperature. Additionally or alternatively, the primary heat source may be related to air dehumidification to the dryer, air cooling to the dryer, heat and solvent recovery from exhaust air of the dryer, cooling of product after evaporation, cooling of product after heat treatment, air conditioning and/or crystallization of product.

The secondary heat source may be any type of lukewarm, moderately hot or warm water source (e.g. condensate from evaporators). For example, in dairy industrial processes, it may be cow water which is the water generated when milk products are evaporated or concentrated.

The heat pump system may comprise one or more heat pumps. Furthermore, a plurality of heat sources, i.e. more than two, may be comprised in the system.

The first sink heater may be the preheater connected to the heat pump system. The first sink heater may constitute a first heat sink heat exchanger. A second sink heater may be comprised in the system, which may act as the process air heater (e.g. steam heater or indirect gas heater) or a second heat sink heat exchanger. The second sink heater may heat the process air, which is comprised or consisted in the sink. For the process air heater or second sink heater, the heat source may be the steam or gas entering into it.

In an embodiment, the second sink heater is arranged after the first sink heater in the flow direction of the process medium and the second sink heater may generate an exhaust medium.

In an alternative or additional embodiment, multiple sink heaters may be comprised in the heating system.

In an embodiment, the primary fluid is a refrigerant in a transcritical cycle, preferably comprising R744. In the transcritical cycle, R744 is found in supercritical phase when releasing heat to produce hot water and in two-phase (subcritical) phase when absorbing heat from one or multiple heat sources, e.g. cold water. The primary fluid is not limited to the afore-mentioned refrigerant and may comprise other refrigerants. In addition, refrigerants operating in other types of cycles may be included, such as reversed Brayton, subcritical, transcritical, cascade, absorption and/or hybrid absorption/compression cycles.

In a presently preferred embodiment, the booster comprises a heat exchanger. Temperature boosting may be achieved by a heat exchanger by means of which the temperature of the primary heat source stream is increased while cooling down an additional heat source stream. The heat exchanger may be a plate, dimple plate, fin-and-tube, shell-and-tube, shell-and-plate or tube-in-tube heat exchanger.

Flow rate boosting may be achieved by mixing the primary heat source stream with the secondary heat stream, for example by means of a valve. The valve may be of a butterfly, ball, check, globe or needle type. Alternatively, a constant flow rate valve may be used, such as a 3-way valve.

In a preferred embodiment, the operating medium is water and/or the process medium of the first sink heater is a gaseous stream.

The heat pump may further operate with a secondary fluid. The secondary fluid may consist or comprise water, or other substances. The exhaust medium from the heater may comprise hot/warm water or flue gas. The gaseous stream of the first sink heater may be an air stream.

In an embodiment, the refrigeration plant is configured to cool down or refrigerate the operating medium.

In an alternative embodiment, the operating medium is heated by heat rejected by the refrigeration plant. This configuration may result in significant cost savings and a stable operation of the heat pump system. Moreover, the system may result in an overall lower electricity consumption.

In an embodiment, the refrigeration plant comprises a refrigeration unit such as a chiller, a heat pump and/or a cooling tower. The chiller may generate ice cold water of approx. 2 °C. The heat pump is thus connected to the refrigeration plant via an ice water or cold water circuit directly or indirectly with any intermediate circuit. The ice or cold or chilled water circuit may comprise water at temperatures being in the range of 1 °C to 40 °C. In cases of water and glycol mixtures, sub-zero temperatures may even be reached (e.g. −10 °C). The heat source may be any process stream cooled by the ice/cold water circuit, e.g. dryer exhaust air, dryer intake air, vapor out of the evaporators or condensate out of evaporator condenser.

The heat pump may be used to cool the ice water providing cooling to one or more processes in the plant, which require cooling.

In a preferred embodiment, the heating system is installed in a drying plant.

The drying plant may comprise a spray drying apparatus.

The list of products which may be spray dried is extensive and include among other ingredients for dairy, food, chemical, agro-chemical, energy, bio-technology, pharmaceutical, semi-pharmaceutical, healthcare, food additives, food ingredients, microorganisms, proteins, peptides, whey, and many more, and are not limited in application to the examples given but are wide open for all such products. Suitable products are defined by their drying characteristics and not by their use or origin.

In an embodiment, the primary fluid of the heat pump comprises carbon dioxide, ammonia, water or hydrocarbon and/or the secondary fluid of the heat pump constitutes water.

In another embodiment, the secondary heat source comprises water as the operating medium.

In yet another embodiment, the heating system further comprises a control device for controlling by flow, pressure and/or temperature the connection of the heat pump with the first sink heater, the primary heat source and/or the booster.

The present system may comprise a control or regulation device. The control device may be a heat pump compressor and/or a control or regulation valve (e.g. butterfly, ball, check, globe, needle type) configured to control the amount of energy delivered from the secondary heat source. Different setups and configurations may be implemented for the operation of the control device.

In a further embodiment, the heating system comprises at least one energy storage tank connected to the heat pump, refrigeration plant and/or secondary heat source. The energy storage tank may be configured to collect the hot or cold water and provide flexibility to the operation of the system. The energy storage tank may also provide stability to the system and increase the amount of active cooling provided since it can act as a buffer for cooling demands. The heating system may further comprise multiple energy storage tanks for example stratified storage tanks or mixing tanks.

In an embodiment, the booster comprises an inlet and an outlet, and the control device is a flow regulation device installed between the booster and the secondary heat source, the heat pump system further comprising a first temperature sensor positioned at the outlet of the booster.

In another embodiment, the control device is configured to operate such that a temperature of the first temperature sensor is in accordance with a temperature setpoint. The temperature setpoint may be predefined according to a set value or may be floating, e.g. based on an algorithm or a model predictive control.

In a further embodiment, the heat pump system further comprises a second temperature sensor positioned at an outlet of the heat pump, wherein the control device is configured to operate such that a temperature of the second temperature sensor is in accordance with a temperature setpoint. The temperature setpoint may be predefined according to a set value or may be floating, e.g. based on an algorithm or a model predictive control.

In an embodiment, the heat pump system further comprises a temperature transmitter connected with the first temperature sensor.

In an embodiment, the heat pump comprises an inlet and an outlet, the heat pump system further comprising a second temperature sensor positioned at the outlet of the heat pump, wherein the control device is configured to operate such that a temperature of the first temperature sensor is in accordance with a temperature at the second temperature sensor. The temperature of the first temperature sensor may be equal, proportional or generally dependent on a temperature at the second temperature sensor.

In a preferred embodiment, the control device is a regulating valve or pump.

In yet another embodiment, the heat pump system further comprises a circulation pump connected with the first sink heater and the heat pump. Other components configured to circulate the operating medium and/or the process medium may be implemented in the system.

The heat pump system may comprise a fluid network and control devices, wherein the heat pump may be connected to the fluid network, wherein the control devices may control the flow, flow direction, pressure and temperature of parts of the fluid network.

The fluid network may comprise the water circuit.

The spray drying apparatus may comprise a series of powder recovery units including a number of filter units, cyclones, scrubbers and/or bag filters, or any combination thereof.

According to a second aspect of the invention, a method for integrating a heating system into a drying plant is provided, the heating system comprising a heat pump system, the heat pump system comprising a heat pump operating with a primary fluid and a first sink heater, the heat pump being connected to the first sink heater, wherein the first sink heater is configured to heat a process medium, the method comprising the steps of
connecting the heat pump to the first sink heater, wherein the first sink heater is configured to preheat a process medium,
connecting the heat pump to a primary heat source,
connecting the primary heat source to a refrigeration plant,
connecting the primary heat source to a secondary heat source via a booster, wherein the booster is configured to adjust the enthalpy flow rate of an operating medium,
preferably adjusting the enthalpy flow rate of an operating medium via or with the booster.

### BRIEF DESCRIPTION OF DRAWINGS

In the following description, embodiments of the invention will be described with reference to the schematic drawings, in which:

FIG. 1 shows a schematic view of a heating system in an embodiment of the present invention showing the control configuration wherein the heating system is installed in a drying plant;

FIG. 2 shows a schematic view of a heating system in another embodiment of the invention;

FIG. 3 shows a schematic view of a heating system in yet another

FIG. 4 shows a schematic view of a heating system in another embodiment of the invention installed in a drying plant;

FIG. 5 shows a schematic view of a heating system in another embodiment of the invention installed in a drying plant.

### DETAILED DESCRIPTION

The present invention will now be described more fully hereinafter with reference to the accompanying drawings, in which embodiments of the invention are shown. This invention may, however, be embodied in many different forms and should not be construed as limited to the embodiments set forth herein; rather, these embodiments are provided for thoroughness and completeness.

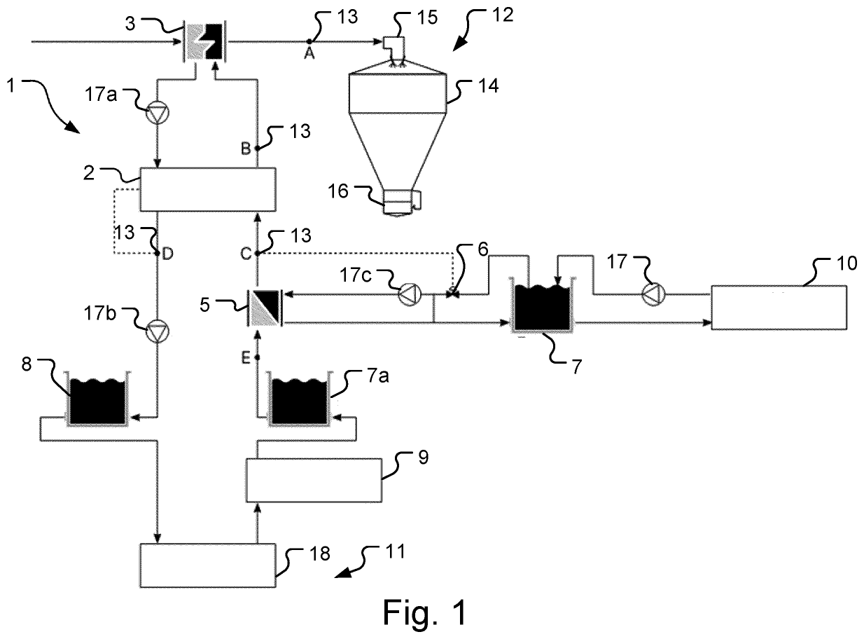

FIG. 1 shows a schematic view of the main components of a heating system 1 comprising a heat pump system. The heat pump system comprises a heat pump 2 operating with a primary fluid and a first sink heater 3, which in this case is a fin and tube air heater. In this case, the primary fluid of the heat pump 2 comprises carbon dioxide. On the hot side, the heat pump 2 (e.g. a CO2 transcritical heat pump) generates hot water (e.g. 130 °C) which is circulated between the heat pump 2 and the first sink heater 3, by means of which the heat pump 2 heats up one air stream of a dryer to high temperature (e.g. 120 °C). On the cold side, the heat pump 2 receives heat by means of a water circuit. The water circuit comprises an operating medium, in this case being water. The operating medium, or water, is heated up by a primary heat source 9, which in this case is heat rejected by ‘cold users’ (e.g. cooling tanks to keep milk at low temperature) from low temperature (e.g. 2 °C) to warmer temperature (e.g. 8 °C) and this moderately warmer water is stored in an intermediate energy storage tank 7a. From the tank 7a, the moderately warmer water is sent to the heat pump evaporator inlet.

At times in which the temperature at this point is too low, a secondary heat source 10 (e.g., condensate collected from evaporators) is used to increase the temperature by means of a heat exchanger or booster 5. To do this, the flow of hot water (e.g. at 40 °C) heated up by means of the secondary heat source 10 is increased by opening a valve 6 forming part of a set of control devices comprised in the heat pump system. The valve 6 will be referred to as “control valve” and is controlled, or regulated, based on the temperature sensed at point C as indicated by the dashed line in FIG. 1. Another energy storage tank 7 is placed in this water loop to collect the hot water and provide buffering capabilities. The operating medium is cooled by the heat pump 2 (e.g. to 3 °C) and the operating medium can then be sent to a buffer tank 8. From the buffer tank 8, the operating medium is then sent to a refrigeration plant 11, which in this embodiment comprises the chiller 18, that is configured to further cool the operating medium down, if needed.

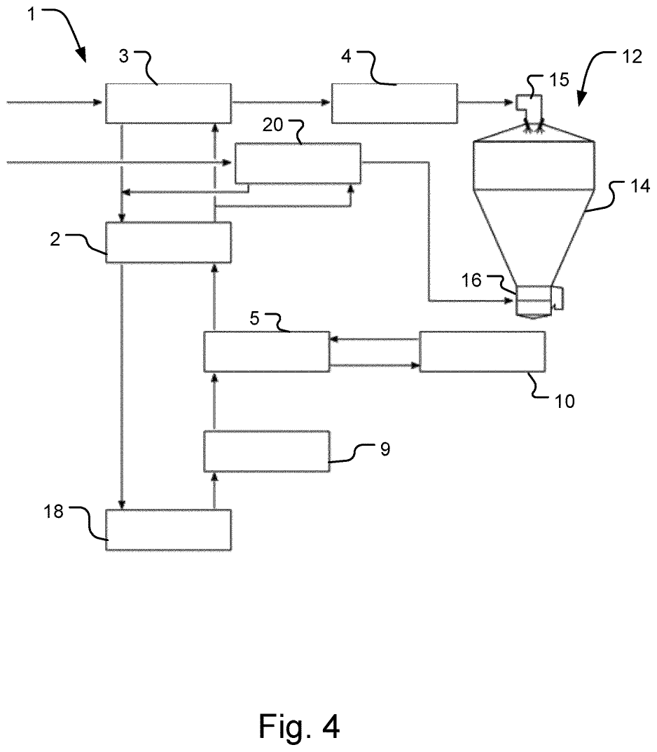

In the embodiments shown in FIGS. 1 and 4, the heating system 1 is installed in a drying plant 12 comprising a spray drying apparatus. The first sink heater 3 constitutes a preheater for drying air or gas to the spray drying apparatus.

The drying plant 12 of the embodiments shown is a multi-stage MSD® Spray Dryer, which combines spray drying and fluid bed drying technology in a three-stage drying process to ensure high overall drying efficiency and product quality. However, any other type of dryer is suitable for being integrated with the system.

The spray drying apparatus comprises a drying chamber 14 and a primary inlet 15 for process air/gas including an air/gas disperser. It is noted that the term “gas” will be used alongside with the term “air” as “air/gas” and is to be interpreted as encompassing any gas that is suitable as process gas in such a spray drying apparatus. The drying chamber 14 also incorporates atomizing means (not shown), such as nozzles and/or an atomizer wheel. The term “drying plant” is intended to encompass such plants in which a powdery or particulate material is processed. The material may either be provided as a feed of powdery or particulate material, or as a liquid feed to be dried. The drying plant 12 is also intended to cover cooling of the particulate material. In addition to or alternatively to the spray drying apparatus described, such a plant could include one or more fluid beds, flash dryers etc.

At the lower end of the drying chamber 14, an outlet 16 for dried or semi-dry intermediate material is provided. In the spray drying apparatus, an after-treatment unit in the form of vibrating or static fluid bed is provided (not shown). At one end, the vibrating or static fluid bed receives dried or semi-dried material from the outlet 16 of the drying chamber 14 for further treatment of the material, which is then to be collected at an outlet at the other end of the vibrating or static fluid bed.

The heat pump system comprises control devices, in this case the valve 6 comprises a 2-way valve, for controlling by flow, pressure and/or temperature the connection of the booster 5 with the secondary heat source 10, as well as a plurality of pumps including circulation pump 17. The 2-way valve 6 is a flow regulation device installed between the booster 5 and the storage tank 7 which is connected to the secondary heat source 10.

The flow, pressure and/or temperature of the operating medium into the booster 5 is controlled. The booster 5 is used for adjusting the enthalpy flow rate of the operating medium that is configured to flow into the booster.

Circulation pumps 17a, 17b, 17c are installed between the heat pump 2 and the first sink heater 3, between the heat pump 2 and the chiller 18, and between the booster 5 and the secondary heat source 10, respectively.

Circulation pumps 17 are controlled at a fixed flow rate, or can be used for controlling the primary and secondary heat sources.

In FIG. 1, temperature sensors 13 are installed at points A, B, C, D and E of the system and are used to control the heat pump capacity. Different controls may be implemented.

In a setup of an embodiment of FIG. 1, the heat pump capacity is controlled by ensuring a setpoint temperature at point D and the secondary heat source 10 is controlled by ensuring a setpoint temperature at point C. In this setup, the heat pump compressors increase capacity if the temperature at point D is above the setpoint and decrease capacity vice versa. Similarly, the control valve 6 in the secondary heat source network opens if the temperature at point C is lower than a setpoint and vice versa. These setpoints may be fixed or floating, and the floating value may be decided based on a model ranging from a simple correlation to a digital twin of the system used in a model predictive control solution.

In the following, alternative embodiments will be described. Elements having the same or analogous function will be described by the same reference numerals throughout the embodiments.

In an alternative embodiment of FIG. 1, the heat pump capacity is controlled by ensuring a setpoint temperature at point B and the secondary heat source 10 is controlled by ensuring a setpoint temperature at point D.

Similarly, in another embodiment of FIG. 1, the heat pump capacity is controlled by ensuring a setpoint temperature at point B and the secondary heat source 10 is controlled by ensuring a setpoint temperature at point C.

Similarly, in yet another embodiment of FIG. 1, the heat pump capacity is controlled by ensuring a setpoint temperature at point A and the secondary heat source 10 is controlled by ensuring a setpoint temperature at point D.

Similarly, in yet another embodiment of FIG. 1, the heat pump capacity is controlled by ensuring a setpoint temperature at point A and the secondary heat source 10 is controlled by ensuring a setpoint temperature at point C.

The circulation pump 17b is controlled for ensuring a setpoint temperature in point D, when the heat pump 2 and control valve 6 are controlled as mentioned above. Similarly, circulation pump 17c is controlled in place of the control valve 6 in the options stated above.

Alternatively or additionally, a hot water pump skid and a cold water pump skid are included in the heating system to circulate water.

A number of conveying lines connect the operational units with each other in a manner known per se and will not be described in detail.

In FIG. 1, the heat pump system comprises four temperature sensors 13, as mentioned previously. The control device comprising the control valve 6 is positioned at the split point between the return line from the storage tank 7 and the booster 5. The booster line is thus controlled via a 2-way valve in the embodiment shown. Alternatively, 3-way valves can be used, either on the booster 5 or heat pump 2 branch, resulting in analogous control logics. The choice between 2- or 3-way valves depends on controllability and economic considerations.

In this way, the 2-way valve 6 is used to regulate the split of water flow between the booster 15 and the secondary heat source 10. The dashed line in FIG. 1 indicates that the valve 6 is controlled based on the temperature sensed at point C. Therefore, the valve 6 is configured to operate such that a temperature of the first temperature sensor is in accordance with a predefined temperature setpoint. A temperature transmitter (not shown) is connected with the temperature sensor 13.

As shown in FIGS. 1-4, the heating system comprises a fluid network and control devices. The heat pump 2 is connected to the fluid network, and the control devices can therefore control the flow, flow direction, pressure and temperature of parts of the fluid network.

The control of water pumps and the heat pump is not described further as it is not a specific feature of the solution. However, different water pump and heat pump control logics could influence the selection of a specific control logic for the booster branch.

The 2-way valve 6 can alternatively be operated with the goal of:
1) making one of the temperature transmitters 13 reach the same value as another temperature transmitter and/or
2) making one of the temperature transmitters 13 reach a predefined or specified setpoint (constant or varying by means of optimizers, predictive models, etc.).

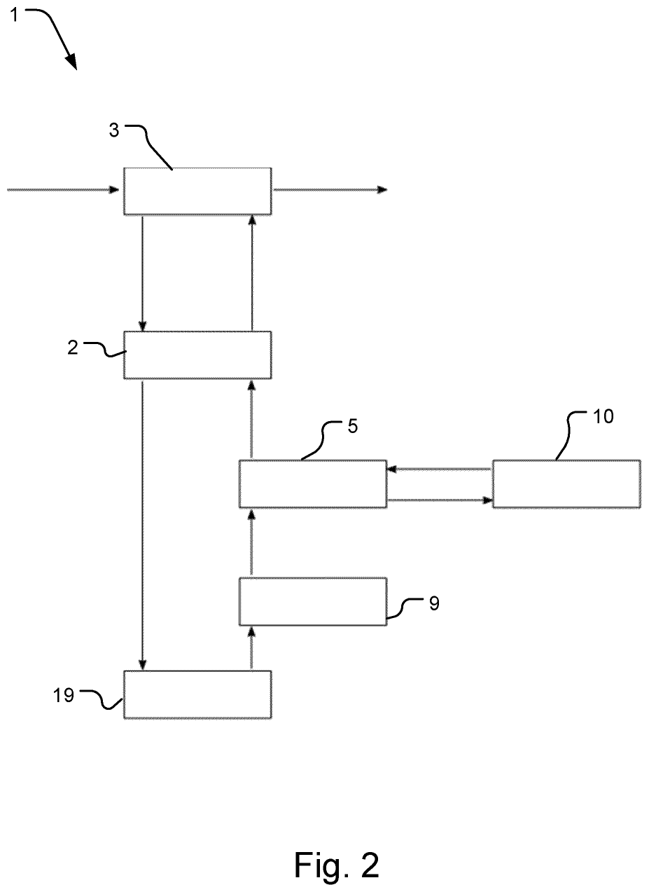

FIG. 2 shows a similar embodiment of the system of FIG. 1. Details of the automation, control and energy storage of the system have been omitted in FIG. 2. The main difference with the embodiment shown in FIG. 1 is that the refrigeration plant here comprises a cooling tower 19, which is connected to the primary heat source 9. The associated costs for running a cooling tower are generally lower than for the embodiment of FIG. 1.

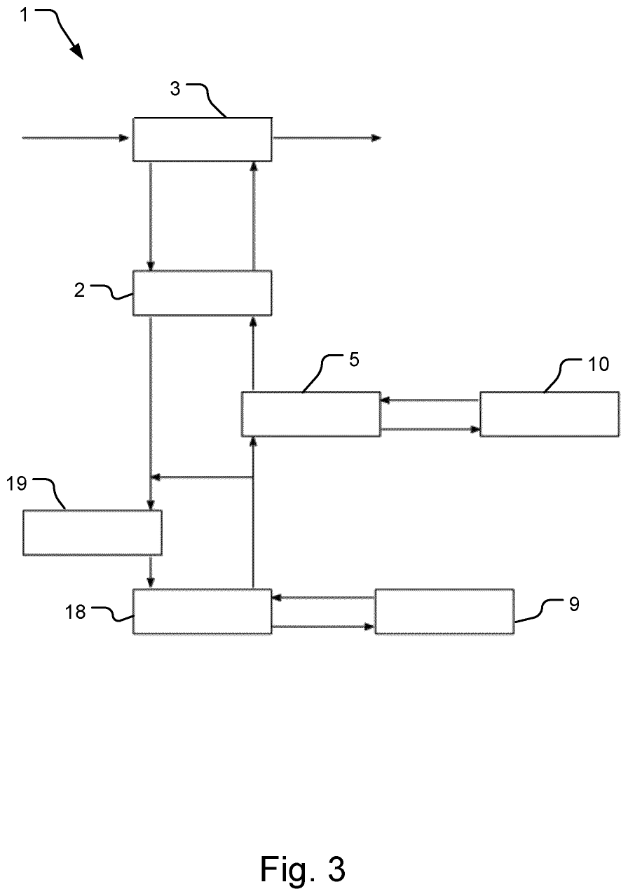

FIG. 3 shows a heating system according to another embodiment of the invention, wherein the booster 5 is connected to the condenser of the heat pump 2. The refrigeration plant comprises a cooling tower 19 connected on the cold side with the heat pump 2, as well as a chiller 18 which is connected between the cooling tower 19 and the primary heat source 9. In this embodiment shown in FIG. 3, the operating medium is heated by heat rejected by the refrigeration plant.

FIG. 4 depicts an alternative embodiment of a heating system 1, similar to the one shown in FIG. 1, but a second sink heater 4 is here connected in series with the first sink heater 3. The second sink heater 4 is arranged after the first sink heater 3 in the flow direction of the process medium and the second sink heater 4 generates the exhaust medium (not shown). The first sink heater 3 constitutes a preheater for drying air to the spray drying apparatus comprised in the drying plant 12, and the second sink heater 4 constitutes a process air heater for drying air to the spray drying apparatus. The air stream exiting the second sink heater 4 enters the dryer, as shown in FIG. 4. In this embodiment, a third sink heater 20 is placed on another air stream, i.e. a second process medium, different to the one that flows into the first sink heater 3 and is configured to transfer heat to the second process medium. The third sink heater 20 is connected directly to the heat pump 2 on the hot side. The process medium exiting the second sink heater 4 enters directly into the dryer, while the exhaust medium exiting the third sink heater 20 flows into the outlet 16 of the drying chamber 14.

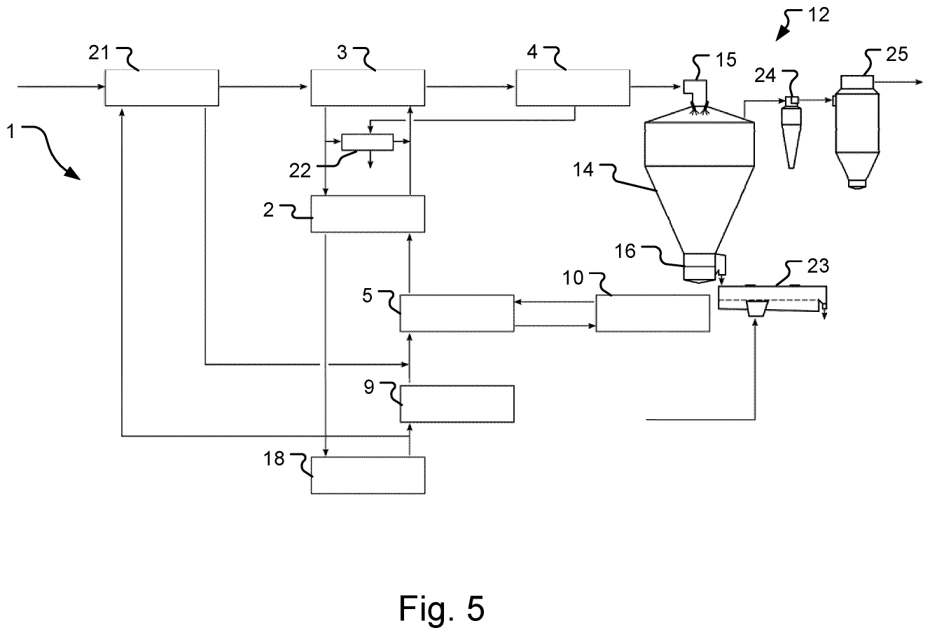

Lastly, FIG. 5 shows an alternative embodiment of a heating system installed in a drying plant 12, where additional components of the spray drying apparatus are shown. The spray drying apparatus here comprises a cyclone 24, to which spent process gas with particles entrained in the process gas is conducted. The process gas conducted to the cyclone 25 can as shown originate from the drying chamber 14 or the vibrating or static fluid bed 23. A separate air stream is shown here to supply the fluid bed 23. The cyclone 25 is connected to a bag filter 25, both with the purpose to recover or collect particles from the spent process gas (not shown), from which exhaust gas is discharged, either to the surroundings or to be recycled, for instance in the case of a closed cycle system in which the exhaust gas leaving the spray drying apparatus is reused as process gas. The heating system shown in FIG. 5 further comprises a dehumidifier 21 installed before the first sink heater 3 in the direction of the process medium. The dehumidifier 21 is here connected in parallel to the primary heat source 9. The purpose of the dehumidifier 21 is to dehumidify the inlet air by means of ice/cold water. The dehumidifier may be any type of heat exchanger. The dehumidifier therefore constitutes an additional heat source, thus constituting a second primary heat source in the embodiment shown. The dehumidifier may include a desiccant material. In this embodiment, an economizer 22 (or heat exchanger) is also connected to the second sink heater 4, between the first sink heater 3 and the heat pump 2 (on the hot side).

As mentioned, the heat pump system further comprises a heat exchanger 22 that is connected to the second sink heater 4 (here acting as the main heater) and is configured to transfer heat from an exhaust medium, which is hot condensate, pressurized water or flue gas, of the second sink heater 4 to a secondary fluid, which in this case is water. The heat exchanger 22 is placed in parallel to the heat pump 2 and provides an economic and effective way to recover energy. The heat exchanger 22 is configured to recover only sensible or sensible and latent heat from the exhaust medium leaving the second sink heater 4. The heat exchanger 22 comprises an inlet and an outlet. The heat exchanger 22 here constitutes an economizer having an inlet connected to the outlet of the process air heater constituted by the second sink heater 4 and an outlet configured to be connected to the inlet of the sink heater 3 (here acting as a preheater). Thus, the heat exchanger 22 has the function of a second or third primary heat source in this embodiment.

### LIST OF REFERENCE NUMERALS

1 Heating system
2 Heat pump
3 First sink heater
4 Second sink heater/process air heater
5 Booster/heat exchanger
6 Control device/valve/2-way valve
7 Hot water storage tank/energy storage tank
7a Intermediate energy storage tank
8 Cold water storage tank
9 Primary heat source
10 Secondary heat source
11 Refrigeration plant
12 Drying plant
13 Temperature transmitter/sensor
14 Drying chamber
15 Primary process gas inlet
16 Outlet of drying chamber
17 Circulation pump
17a Circulation pump
17b Circulation pump
17c Circulation pump
18 Chiller
19 Cooling tower
20 Third sink heater
21 Dehumidifier
22 Heat exchanger/Economizer
23 Fluidizer
24 Cyclone
25 Bag filter

What is claimed is:

1. A heating system for a drying plant, the heating system comprising a heat pump system, the heat pump system comprising a heat pump operating with a primary fluid and a first sink heater, the heat pump being connected to the first sink heater, wherein the first sink heater is configured to heat a process medium,
the heating system further comprising at least one primary heat source and one secondary heat source, the heat pump being connected to the primary heat source,
wherein the primary heat source is connected to a refrigeration plant, the primary heat source being connected to the secondary heat source via a booster,
where the booster comprises a heat exchanger,
wherein there is an operating medium which is configured to be heated by the primary heat source or the refrigeration plant to give a primary heat source stream,
wherein in the heat exchanger a temperature of the primary heat source stream is increased while cooling down an additional heat source stream, wherein the additional heat source stream is a secondary heat stream from the secondary heat source,
wherein the operating medium is configured to flow into the booster and the booster is configured to adjust an enthalpy flow rate of the operating medium, where the operating medium is water and the process medium of the first sink heater is a gaseous stream.

2. A heating system according to claim 1, wherein the heating system further comprises a second primary heat source, the second primary heat source being placed in parallel with the primary heat source.

3. A heating system according to claim 1, wherein the refrigeration plant is configured to refrigerate the operating medium.

4. A heating system according to claim 1, wherein the refrigeration plant comprises a refrigeration unit such as one or more of a chiller, a heat pump, or a cooling tower.

5. A heating system according to claim 1, wherein the heating system further comprises a control device for controlling by flow, pressure and/or temperature the connection of the heat pump with one or more of the first sink heater, the primary heat source, or the booster.

6. A heating system according to claim 1, wherein the heating system comprises at least one energy storage tank connected to one or more of the heat pump, the refrigeration plant, or the secondary heat source.

7. A heating system according to claim 5, wherein the booster comprises an inlet and an outlet, and the control device is a flow regulation device installed between the booster and the secondary heat source, the heat pump system further comprising a first temperature sensor positioned at the outlet of the booster.

8. A heating system according to claim 7, wherein the control device is configured to operate such that a temperature of the first temperature sensor is in accordance with a temperature setpoint.

9. A heating system according to claim 5, wherein the control device is a regulating valve or pump.

10. A method for integrating a heating system into a drying plant, the heating system comprising a heat pump system, the heat pump system comprising a heat pump operating with a primary fluid and a first sink heater, the heat pump being connected to the first sink heater, wherein the first sink heater is configured to heat a process medium, the method comprising:
connecting the heat pump to the first sink heater, wherein the first sink heater is configured to preheat the process medium,
connecting the heat pump to a primary heat source,
connecting the primary heat source to a refrigeration plant, and
connecting the primary heat source to a secondary heat source via a booster,
wherein the booster is configured to adjust an enthalpy flow rate of an operating medium.
